(19) United States
(12) Patent Application Publication
(10) Pub. No.: US 2026/0070365 A1
(43) Pub. Date: Mar. 12, 2026

(54) METHOD FOR MANUFACTURING PRINTED MATTER

(71) Applicant: MIMAKI ENGINEERING CO., LTD., Nagano (JP)

(72) Inventors: Hiromi Suganuma, Nagano (JP); Akira Takatsu, Nagano (JP)

(73) Assignee: MIMAKI ENGINEERING CO., LTD., Nagano (JP)

(21) Appl. No.: 19/108,426

(22) PCT Filed: Aug. 28, 2023
(86) PCT No.: PCT/JP2023/030913

§ 371 Date: Mar. 3, 2025

(30) Foreign Application Priority Data
Nov. 17, 2022 (JP) 2022-183907

(51) Int. Cl. B41M 7/00; B41J 2/01; B41M 5/00

(52) U.S. Cl. CPC B41M 7/0018; B41J 2/01; B41M 5/00

(57) ABSTRACT

There is provided a method for manufacturing printed matter having a print layer that can be removed from a base material but does not easily peel off from the base material. A method for manufacturing printed matter includes: a base layer forming step; a print layer forming step; a print quality checking step; and a post-processing step. In the base layer forming step, a base layer which is removable from a base material is formed on a front surface of the base material. In the print layer forming step, a print layer is formed on a surface of the base layer on a side opposite to the base material. In the print quality checking step, a quality of the print layer is checked. In the post-processing step, a coating layer that coats the print layer is formed or the print layer is removed together with the base layer from the base material depending on the quality of the print layer.

### TECHNICAL FIELD

The present invention relates to a method for manufacturing printed matter.

### BACKGROUND ART

Printed matter has, on a base material, a print layer indicating information such as an image. There are known methods of removing the print layer from the base material and reusing the base material in such printed matter. This enables printing to be repeated with the same base material, thus reducing waste of the base material, for example, in a case where a quality of a print layer does not satisfy a predetermined criterion, and remanufacturing of the printed matter is performed.

For example, Patent Literature 1 discloses a method of dissolving an ink constituting a print layer by using a solvent to remove the print layer from a base material.

### CITATION LIST

### Patent Literature

Patent Literature 1: Japanese Unexamined Patent Publication No. 2016-65213

### SUMMARY OF INVENTION

### Technical Problems

The present inventors have found from study that a print layer made of an ink which can be removed from a base material may have a low adhesion to the base material. Therefore, in printed matter (for example, a final product) in which the quality of the printed matter satisfies predetermined criteria and reprinting (removal of a print layer) is not required, the print layer tends to easily peel off from the base material.

In this respect, the present invention meets a demand for providing a method for manufacturing printed matter having a print layer that can be removed from a base material but does not easily peel off from the base material.

### Solutions to Problems

A method for manufacturing printed matter according to one aspect of the present invention includes:
a base layer forming step: a print layer forming step; a print quality checking step; and a post-processing step. In the base layer forming step, a base layer which is removable from a base material is formed on a front surface of the base material. In the print layer forming step, a print layer is formed on a surface of the base layer on a side opposite to the base material. In the print quality checking step, a quality of the print layer is checked. In the post-processing step, a coating layer that coats the print layer is formed or the print layer is removed together with the base layer from the base material depending on the quality of the print layer.

According to the aspect, it is possible to provide printed matter having the print layer that can be removed from the base material but does not easily peel off from the base material.

### BRIEF DESCRIPTION OF THE DRAWINGS

FIG. 1 is a flowchart of a method for manufacturing printed matter according to an embodiment.

FIG. 2 is a plan view (upper) and a cross-sectional view (lower) illustrating a state in which a base layer and a print layer are formed.

FIG. 3 is a plan view (upper) and a cross-sectional view (lower) illustrating a state in which the base layer, the print layer, and a coating layer are formed.

FIG. 4 is a flowchart of a method for manufacturing printed matter according to a modification example.

### DESCRIPTION OF EMBODIMENTS

Hereinafter, a method for manufacturing printed matter according to the present embodiment will be described in detail with reference to the drawings.

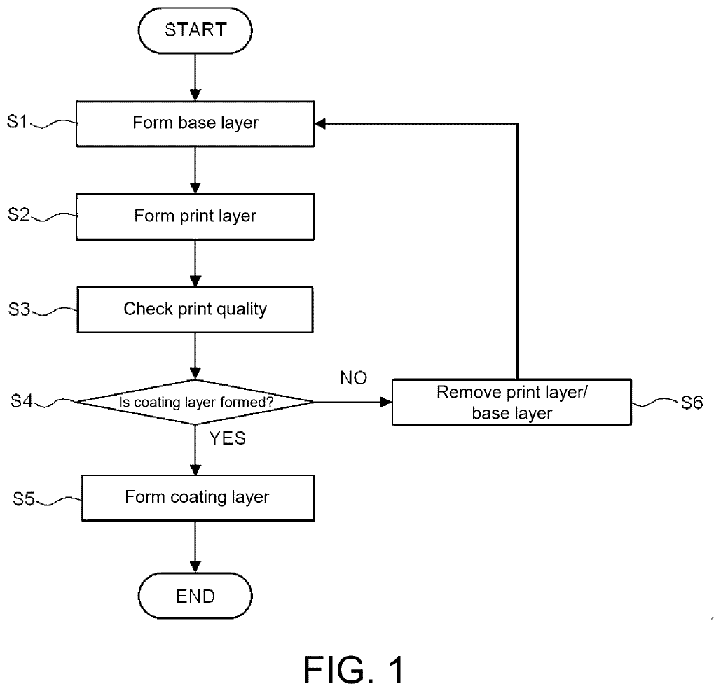

FIG. 1 is a flowchart of the method for manufacturing printed matter according to the embodiment.

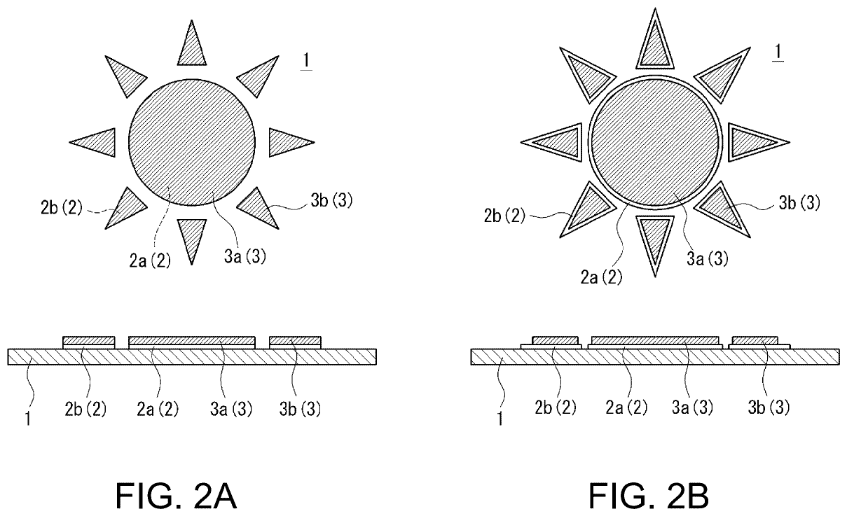

FIG. 2 is a plan view (upper) and a cross-sectional view (lower) illustrating a state in which a base layer 2 and a print layer 3 are formed. FIG. 2(a) illustrates that a size of the base layer 2 is substantially equal to a size of the print layer 3. FIG. 2(b) illustrates that the size of the base layer 2 is slightly larger than the size of the print layer 3.

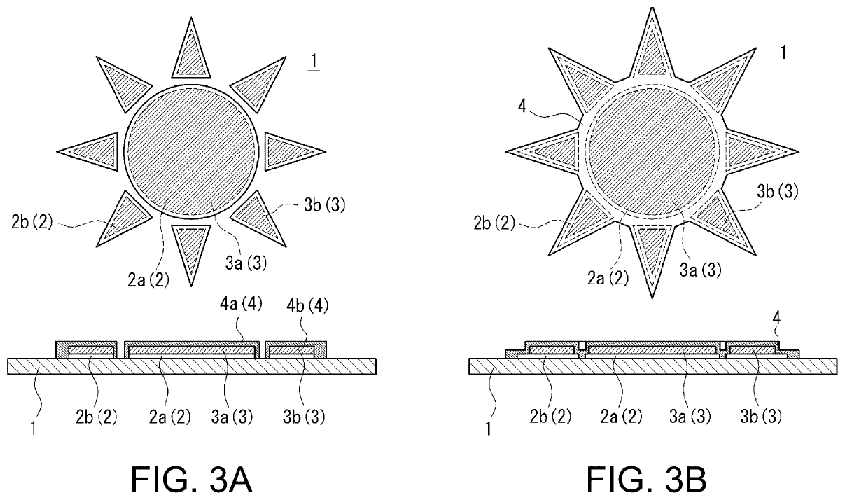

FIG. 3 is a plan view (upper) and a cross-sectional view (lower) illustrating a state in which the base layer 2, the print layer 3, and a coating layer 4 are formed. FIG. 3(a) illustrates that the coating layer 4 is provided individually for each of a plurality of regions to be coated. FIG. 3(b) illustrates that the coating layer 4 is provided to collectively cover the plurality of regions to be coated.

In the following description, the upper side in FIGS. 2 and 3 is defined as “upper” or “upward”, and the lower side is defined as “lower” or “downward”.

The method for manufacturing printed matter illustrated in FIG. 1 includes a base layer forming step S1, a print layer forming step S2, a print quality checking step S3, a coating layer formation determining step S4, and a coating layer forming step S5 and a print layer/base layer removing step S6 as post-processing steps.

Hereinafter, all of the steps will be sequentially described.

### <Base Layer Forming Step S1>

In the base layer forming step S1, the base layer 2 that can be removed from the base material (medium) 1 is formed on an upper surface (front surface) of the base material 1.

First, the base material 1 is prepared.

As the base material 1, a resin base material made of polyester (polyethylene terephthalate or the like), an olefinic elastomer, or the like is preferable, but a paper base material, a ceramic base material, or the like may be used.

In addition, a shape of the base material 1 may be any shape such as a sheet shape, a flat plate shape, or any three-dimensional shape, for example.

Note that the base material 1 may have an ink receiving layer in the vicinity of the front surface thereof, that is, may have a base material body and an ink receiving layer formed on the front surface of the base material body.

Next, the base layer 2 is formed on the upper surface of the base material 1.

The base layer 2 is formed by supplying a first ink (base layer forming ink) to the upper surface of the base material 1. A method of supplying the first ink is not particularly limited, and examples thereof include a droplet ejection method (inkjet method), a bar coating method, a wire bar coating method, a spin coating method, a casting method, a micro gravure coating method, a gravure coating method, a roll coating method, a dip coating method, a spray coating method, a screen printing method, a flexographic printing method, and an offset printing method.

Among these methods, the droplet ejection method or the bar coating method is preferable as the method of supplying the first ink. That is, the base layer 2 is suitably formed by the droplet ejection method or the bar coating method. The droplet ejection method makes it easy to accurately form the base layer 2 having a shape corresponding to the shape of the print layer 3 to be described below. In addition, the droplet ejection method enables the base layer 2 having a fine shape to be accurately formed.

In addition, according to the bar coating method, the base layer 2 having a relatively large area can be easily formed to have a uniform thickness.

The base layer 2 is formed to be removable from the base material 1, and the removal is preferably performed by at least one selected from contact with a solvent, ultraviolet irradiation, heating, and plasma treatment.

In a case where the base layer 2 is removed by the contact with a solvent, examples of the usable solvent include water, a weak alkaline solution, and an organic solvent (alcohols, esters, or the like). Hence, the base layer 2 that can be removed by the contact with a solvent is formed to contain, for example, a water-soluble compound.

Examples of the water-soluble compound preferably include water-soluble resins such as polyvinyl alcohol (PVA), butenediol vinyl alcohol copolymer (BVOH), and polyallylamine (PAA). These water-soluble resins may be used singly or in a combination of two or more kinds thereof.

In addition, the molecular weight (weight average molecular weight) of the water-soluble resins is not particularly limited, and is preferably about 1,000 or more and 7,500 or less, more preferably about 1,250 or more and 5,000 or less, and still more preferably about 1,500 or more and 3,000 or less. The water-soluble resin having such a molecular weight can maintain sufficiently high water solubility without causing reduction in the strength of the base layer 2.

Note that the weight average molecular weight of a resin is obtained as a conversion value in terms of standard polystyrene by a gel permeation chromatography (GPC) method.

In a case where the base layer 2 is removed by the ultraviolet irradiation, the base layer 2 contains, for example, an ultraviolet decomposable compound.

Examples of the ultraviolet decomposable compound preferably include ultraviolet decomposable resins such as polyethylene, polypropylene, polyvinyl chloride, polylactic acid to which a small amount of sugar polymer units are added, an acrylic resin, a polyester-based resin, and a urethane-based resin. These ultraviolet decomposable resins may be used singly or in a combination of two or more kinds thereof.

In a case where the base layer 2 is removed by heat, the base layer 2 contains, for example, a thermally decomposable compound.

Examples of the thermally decomposable compound preferably include thermally decomposable resins such as ethyl cellulose, alkylated, (meth)acrylated, or epoxidized polyalkylene glycol (polyethylene glycol, polypropylene glycol, or the like), a polymer of (meth)acrylic acid ester having an alkyl group with one to six carbon atoms, poly(meth)acrylic acid, polystyrene, and crosslinked polystyrene. These thermally decomposable resins may be used singly or in a combination of two or more kinds thereof.

In addition, the base layer 2 may include, for example, a resin having a glass transition temperature (Tg) of about room temperature and thermally expandable particles. In this case, the base layer 2 is highly softened at a temperature slightly higher than room temperature (25° C.), or the thermally expandable particles are thermally expanded, thereby applying physical stress thereto, so that the base layer 2 can peel off from the base material 1.

Examples of the resin having the Tg of about room temperature include polyethylene, polypropylene, polyurethane, polyethyl acrylate, and polybutyl acrylate. These resins may be used singly or in a combination of two or more kinds thereof.

Examples of constituent materials of the thermally expandable particles include an acrylic resin such as an acrylonitrile copolymer, an amide resin, and a styrene resin. These materials may be used singly or in a combination of two or more kinds thereof.

The thermally expandable particles may be hollow or solid, and are preferably hollow. Since the thermally expandable hollow particles contain gas, a volume change due to thermal expansion can be further increased.

Examples of the gas contained in the thermally expandable particles include air, ethane, ethylene, propane, propene, n-butane, isobutane, butene, isobutene, n-pentane, isopentane, neopentane, n-hexane, heptane, low-molecular-weight hydrocarbons (low-boiling hydrocarbons) such as petroleum ether, chlorofluorocarbons such as CCl₃F, CCl₂F₂, and CClF₃, and tetraalkylsilanes such as tetramethylsilane, trimethylethylsilane, and trimethylisopropylsilane.

In a case where the base layer 2 is removed by the plasma treatment, the base layer 2 contains, for example, a plasma decomposable compound.

Examples of the plasma decomposable compound preferably include plasma decomposable resins such as a polymer of (meth)acrylic acid ester having an alkyl group with one to six carbon atoms, polyvinyl alcohol, polyvinyl acetate, cellulose and derivatives thereof, or a copolymer containing these as a main component. These plasma-decomposable resins may be used singly or in a combination of two or more kinds thereof.

A solvent or a dispersion medium used to prepare the first ink by dissolving or dispersing the above components is preferably a hydrophilic solvent.

Examples of the hydrophilic solvent include water, alcohols with three or less carbon atoms such as methanol, ethanol, 1-propanol, and 2-propanol, glycol ethers such as ethylene glycol monomethyl ether and propylene glycol monomethyl ether, amides such as N,N-dimethylformamide and N-methylpyrrolidone, lactones such as γ-butyrolactone, γ-valerolactone, and ε-caprolactone, ketones such as acetone, and dimethyl sulfoxide. These solvents may be used singly or in a combination of two or more kinds thereof.

For example, various surfactants can be added to the first ink for the purpose of improving wettability thereof to the upper surface of the base material 1. As the surfactant, any one of cationic, anionic, amphoteric, and nonionic surfactants can be used.

The cationic surfactant is not particularly limited, and examples thereof include aliphatic amine salt, aliphatic quaternary ammonium salt, benzalkonium salt, benzethonium chloride, pyridinium salt, and imidazolinium salt.

The anionic surfactant is not particularly limited, and examples thereof include fatty acid soap, N-acyl-N-methylglycine salt, N-acyl-N-methyl-β-alanine salt, N-acylglutamate, alkyl ether carboxylate, acylated peptide, alkyl sulfonate, alkyl benzene sulfonate, alkyl naphthalene sulfonate, dialkyl sulfosuccinate salt, alkyl sulfoacetate, α-olefin sulfonate, N-acyl methyl taurine, sulfated oil, higher alcohol sulfate, secondary alcohol sulfate, alkyl ether sulfate, secondary alcohol ethoxy sulfate, polyoxyethylene alkyl phenyl ether sulfate, monoglysulfate, fatty acid alkylolamide sulfate salt, alkyl ether phosphate ester salt, and alkyl phosphate ester salt.

The amphoteric surfactant is not particularly limited, and examples thereof include carboxybetaine type, sulfobetaine type, aminocarboxylate, and imidazolinium betaine surfactant.

The nonionic surfactant is not particularly limited, and examples thereof include polyoxyethylene alkyl ether, polyoxyethylene secondary alcohol ether, polyoxyethylene alkylphenyl ether, polyoxyethylene sterol ether, polyoxyethylene lanolin derivative, polyoxyethylene polyoxypropylene alkyl ether, polyoxyethylene glycerin fatty acid ester, polyoxyethylene castor oil, hydrogenated castor oil, polyoxyethylene sorbitan fatty acid ester, polyoxyethylene sorbitol fatty acid ester, polyethylene glycol fatty acid ester, fatty acid monoglyceride, polyglycerin fatty acid ester, sorbitan fatty acid ester, propylene glycol fatty acid ester, sucrose fatty acid ester, fatty acid alkanolamide, polyoxyethylene fatty acid amide, polyoxyethylene alkylamine, alkylamine oxide, acetylene glycol, acetylene alcohol, polyether-modified polydimethylsiloxane, and polyester-modified polydimethylsiloxane.

These surfactants may be used singly or in a combination of two or more kinds thereof.

A surfactant content in the first ink is not particularly limited, and is preferably about 0.001 mass % or higher and 5 mass % or lower, more preferably about 0.01 mass % or higher and 1 mass % or lower, and still more preferably about 0.1 mass % or higher and 0.5 mass % or lower. Adjustment of the surfactant content within such a range enables the surface tension of the first ink to be randomly adjusted, and in particular, to be adjusted to a range suitable for the droplet ejection method.

The first ink may contain a photo-curable compound. In this case, photo-curability (photopolymerizability) can be imparted to the first ink.

In a case where the water-soluble compound is used, a water-soluble photo-curable compound is suitably used as the photo-curable compound.

Examples of the water-soluble photo-curable compound include an acrylamide compound, a monofunctional (meth)acrylate compound, and a polyfunctional (meth)acrylate compound.

Examples of the acrylamide compound include (meth)acrylamide derivatives with three to fifteen carbon atoms, hydroxyl group-containing (meth)acrylates with five to fifteen carbon atoms, hydroxyl group-containing (meth)acrylates having a number average molecular weight (Mn) of 200 to 1,000, and (meth)acryloylmorpholine.

Examples of the (meth)acrylamide derivatives with three to fifteen carbon atoms include (meth)acrylamide, N-methyl (meth)acrylamide, N-ethyl (meth)acrylamide, N-propyl (meth)acrylamide, N-butyl (meth)acrylamide, N,N′-dimethyl (meth)acrylamide, N,N′-diethyl (meth)acrylamide, N-hydroxyethyl (meth)acrylamide (HEAA), N-hydroxypropyl (meth)acrylamide, and N-hydroxybutyl (meth)acrylamide.

Examples of the hydroxyl group-containing (meth)acrylates with five to fifteen carbon atoms include hydroxyethyl (meth)acrylate, hydroxypropyl (meth)acrylate, and 4-hydroxybutyl (meth)acrylate.

Examples of the hydroxyl group-containing (meth)acrylates having the number average molecular weight (Mn) of 200 to 1,000 include polyethylene glycol mono(meth)acrylate, monoalkoxy (one to four carbon atoms) polyethylene glycol mono(meth)acrylate, polypropylene glycol mono(meth)acrylate, monoalkoxy (one to four carbon atoms) polypropylene glycol mono(meth)acrylate, and mono(meth)acrylate of polyethylene glycol (PEG)-polypropylene glycol (PPG) block polymer.

The monofunctional (meth)acrylate-based compound is preferably a monofunctional (meth)acrylate-based compound having high polarity.

Specific examples of the monofunctional (meth)acrylate-based compound include vinyl group-containing lactams such as N-vinylpyrrolidone and N-vinylcaprolactam, acryloylmorpholine, dimethylaminoethyl (meth)acrylate, and N,N-dimethylaminopropyl (meth)acrylamide.

The polyfunctional (meth)acrylate-based compound is preferably a polyfunctional (meth)acrylate-based compound having an aliphatic polyether structure or an aliphatic polyester structure.

Specific examples of the polyfunctional (meth)acrylate-based compound include tetramethylene glycol diacrylate, hexamethylene glycol diacrylate, polyethylene glycol diacrylate, polytetramethylene glycol diacrylate, polypropylene glycol diacrylate, and polyester diol diacrylate.

In addition, as the polyfunctional (meth)acrylate-based compound, urethane (meth)acrylate having the aliphatic polyether structure or the aliphatic polyester structure is also suitably used.

The number average molecular weight (Mn) of the aliphatic polyether structure or the aliphatic polyester structure of these polyfunctional (meth)acrylates is preferably 600 or more and 2,000 or less, and more preferably 800 or more and 1,500 or less.

In a case where the photo-curable compound is used, it is preferable to add a photocuring initiator to the first ink.

The photocuring initiator may be a compound that starts curing (polymerization) of the photo-curable compound when irradiated with light, and examples thereof include a photopolymerization initiator.

The photopolymerization initiators may be used singly or in a combination of two or more kinds thereof, or may further be used in a combination of a sensitizer. The selection, a combination, and a compounding ratio of the main photopolymerization initiator and a sensitizer may be appropriately determined depending on the type of the photo-curable compound to be used, the type of the base material, and the like.

Examples of the photopolymerization initiator include 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropane-1-one, 2-hydroxy-2-methyl-1 phenylpropane-1 one, thioxanthone, diethylthioxanthone, 2-isopropylthioxanthone, 2-chlorothioxanthone, 2-methyl-1-[4-(methylthio)phenyl]-2-morpholino-propane-1-one, 2,4,6-trimethylbenzoyldiphenylphosphine oxide, bis-(2,6-dimethoxybenzoyl)-2,4,4-trimethylpentylphosphine oxide, and bis(2,4,6-trimethylbenzoyl)-phenylphosphine oxide.

Examples of the sensitizer include an amine-based (aliphatic amine, amine containing an aromatic group, piperidine, or the like) sensitizer, urea (allyl-based, o-tolylthiourea, or the like), a sulfur compound (sodium diethyldithiophosphate, soluble salt of aromatic sulfinic acid, or the like), a nitrile-based compound (N,N-disubstituted p-aminobenzonitrile or the like), a phosphorus compound (tri-n-butylphosphine, sodium diethyldithiophosphate, or the like), a nitrogen compound (Michler's ketone, an N-nitriso hydroxylamine derivative, an oxazolidine compound, a tetrahydro-1,3-oxazine compound, condensate of formaldehyde or acetaldehyde with diamine, or the like), a chlorine compound (carbon tetrachloride, hexachloroethane, or the like), polymerized amine which is a reaction product of epoxy resin and amine, and triethanolamine triacrylate.

Further, an antiseptic agent, an antifungal agent, a pH adjuster, a viscosity modifier, a dispersant, or the like can be added to the first ink, as necessary.

The long-term storage stability of the first ink can be maintained by adding the antiseptic agent or the antifungal agent. Examples of the antiseptic agent or the antifungal agent include an aromatic halogen compound, methylene dithiocyanate, a halogen-containing nitrogen-sulfur compound, and 1,2-benzisothiazoline-3-one.

A coating film (liquid coating film) of the first ink supplied to the upper surface of the base material 1 is dried, thereby solidifying a solid component contained in the first ink to obtain a dry coating film. This drying can be performed by natural drying, reduced-pressure drying, blow drying, heat drying, or the like. In addition, drying may be performed by combining two or more drying methods.

This dry coating film may be used as a base layer as it is, or may be subjected to heat treatment in a case where the first ink that is not easily affected by heat is used.

A heat treatment temperature is not particularly limited, and is preferably about 40° C. or higher and 120° C. or lower, and more preferably about 60° C. or higher and 100° C. or lower.

A heat treatment time is also not particularly limited, and is preferably about 1 minute or longer and 30 minutes or shorter, and more preferably about 5 minutes or longer and 20 minutes or shorter.

In addition, in a case where the first ink contains a photo-curable compound, the liquid coating film or the dry coating film can be irradiated with an ultraviolet ray (active energy ray).

As a lamp that generates an ultraviolet ray, for example, an ultraviolet light emitting diode (UV-LED), a metal halide lamp, a high pressure mercury lamp, an ultra-high pressure mercury lamp, a fluorescent tube, or the like can be used.

In addition, the ultraviolet ray with which to perform irradiation is preferably an ultraviolet ray having a wavelength of about 300 nm or longer and 400 nm or shorter, and is more preferably used after a predetermined wavelength is cut as necessary.

A temperature at the time of ultraviolet irradiation is preferably about 15° C. or higher and 100° C. or lower, and more preferably about 20° C. or higher and 50° C. or lower. Since UV curing is an exothermic reaction, the temperature may be adjusted reflecting a type of monomer contained in the first ink, and the like when that the reaction is accelerated as the temperature increases is taken into consideration.

The intensity of an ultraviolet ray with which to perform irradiation is preferably about 0.1 mW/cm² or higher and 100 W/cm² or lower, and more preferably about 2 mW/cm² or higher and 50 W/cm² or lower. Note that the irradiation with the ultraviolet ray may be performed while the intensity is changed. In addition, the irradiation with the ultraviolet ray may be performed continuously or intermittently (in a pulsed manner).

An energy quantity of the ultraviolet ray with which to perform irradiation can be adjusted as appropriate, and is preferably about 10 mJ/cm² or larger and 500 J/cm² or smaller, and more preferably about 100 mJ/cm² or larger and 200 J/cm² or smaller.

A thickness of a liquid coating film which becomes the base layer 2 is not particularly limited, and is preferably about 0.05 μm or larger and 20 μm or smaller, and more preferably about 0.1 μm or larger and 25 μm or smaller. The base layer 2 having such a thickness can exhibit an excellent removal effect (decomposition effect or peeling effect) from the base material 1 when necessary while maintaining sufficient strength.

Note that, in a case where the first ink containing polyallylamine (PAA) as the water-soluble compound is used, a second ink (print layer forming ink) to be described below may be supplied onto the liquid coating film (a surface on an opposite side to the base material 1) of the first ink supplied to the front surface of the base material. That is, the print layer 3 may be formed by so-called wet on wet.

The first ink to be used is appropriately selected based on a constituent material, a front surface state, a front surface treatment, a chemical treatment, or the like of the base material 1 by reflecting the wettability of the first ink to the upper surface of the base material 1, an adhesion of the base layer 2 to be formed to the base material 1, or the like.

The viscosity of the first ink at room temperature (25° C.) is preferably about 20 mPa·s or lower, and more preferably about 3 mPa·s or higher and 15 mPa·s or lower. In this case, it is easy to form the uniform base layer 2 having a uniform thickness.

The base layer 2 may be a single layer formed of only one type of first ink, or may be a layered body having a plurality of layers formed of two or more types of first inks. In the latter case, the base layer 2 can include a first base layer formed on the base material 1 side and a second base layer which is formed on the first base layer on a side opposite to the base material 1 and has a higher adhesion to the print layer 2 than an adhesion of the first base layer thereto. This enables the print layer 3 to stably adhere to the base layer (second base layer) 2. In this case, the first base layer preferably has a higher adhesion to the base material 1 than that of the second base layer thereto. This enables the base layer 2 to stably adhere on the base material 1.

Note that an intermediate layer may be provided between the first base layer and the second base layer, for example, for the purpose of improving an adhesion therebetween.

In the present embodiment, as illustrated in FIGS. 2(a) and 2(b), a circular central base layer 2a and a plurality of outer peripheral base layers 2b arranged along an outer periphery of the central base layer 2a are formed as the base layer 2.

A size of the base layer 2 (the central base layer 2a and the outer peripheral base layers 2b) may be substantially equal to (see FIG. 2(a)) or slightly larger (see FIG. 2(b)) than a size of the print layer 3 to be formed next.

According to such a configuration, a region of the base material 1 which is exposed from the base layer 2 and the print layer 3 can be sufficiently secured. Therefore, in a case where the base layer 2 is removed by the contact with a solvent, a sufficient contact area of the base layer 2 with the solvent can be secured, and the base layer 2 can be quickly removed. In addition, as will be described below, in a case where the coating layer 4 is formed, a sufficient contact area can be secured between the base material 1 and the coating layer 4, and it is easy to prevent the coating layer 4 from peeling off from the base material 1.

### <Print Layer Forming Step S2>

In the print layer forming step S2, the print layer 3 is formed on an upper surface of the base layer 2 (a surface on a side opposite to the base material 1).

The print layer 3 is formed by supplying a second ink (print layer forming ink) to the upper surface of the base layer 2. A method of supplying the second ink is not particularly limited, and examples thereof include a droplet ejection method (inkjet method), a bar coating method, a wire bar coating method, a spin coating method, a casting method, a micro gravure coating method, a gravure coating method, a roll coating method, a dip coating method, a spray coating method, a screen printing method, a flexographic printing method, and an offset printing method.

Among these methods, the droplet ejection method is preferable as the method of supplying the second ink. That is, the print layer 3 is suitably formed by the droplet ejection method. The droplet ejection method makes it easy to accurately form the print layer 3 having a shape corresponding to the shape of the base layer 2. In addition, the droplet ejection method enables the print layer 3 having a fine shape to be accurately formed.

Examples of the second ink that can be used for forming the print layer 3 include a photo-curable ink, a water-based ink, a solvent ink, and the like.

### <<Photo-Curable Ink>>

The photo-curable ink preferably contains at least a photo-curable compound and a colorant.

Examples of the photo-curable compound include unsaturated carboxylic acid (acrylic acid, methacrylic acid, itaconic acid, fumaric acid, and maleic acid) or esters thereof, styrene, a styrene derivative (vinyltoluene, dimethylstyrene, or the like), an N-vinyl compound (N-vinylpyrrolidone, N-vinylcaprolactam, N-vinylformamide, N-vinylacetamide, or the like), N-substituted maleimide, acrylonitrile, acryloylmorpholine, polyester acrylate, polyurethane acrylate, epoxy acrylate, polyether acrylate, oligoacrylate, alkyd acrylate, polyol acrylate, polyester methacrylate, polyurethane methacrylate, epoxy methacrylate, polyether methacrylate, oligomethacrylate, alkyd methacrylate, and polyol methacrylate.

Among the compounds, the photo-curable compound preferably contains at least one of acrylic acid esters and N-vinyl compounds. These photo-curable compounds are preferable because the photo-curable compounds are excellent in photopolymerizability. In addition, the print layer 3 having a high adhesion to the base layer 2 can also be formed.

Examples of the acrylic acid esters include monofunctional (meth)acrylate such as hexyl (meth)acrylate, 2-(2-methoxyethoxy)ethyl (meth)acrylate, glycidyl (meth)acrylate, glycidyloxybutyl (meth)acrylate, 3-hydroxypropyl (meth)acrylate, dimethylaminopropyl (meth)acrylate, or EO-modified phenol (meth)acrylate, and polyfunctional (meth)acrylate such as 1,6-hexanediol di(meth)acrylate, dipropylene glycol di(meth)acrylate, polyethylene glycol di(meth)acrylate, EO-modified bisphenol A di(meth)acrylate, bisphenol F polyethoxy di(meth)acrylate, trimethylolpropane tri(meth)acrylate, sorbitol tri(meth)acrylate, pentaerythritol tetra(meth)acrylate, and dipentaerythritol hexa(meth)acrylate.

The colorant is selected from a pigment and a dye, and it is preferable to use a pigment from the viewpoint of improving light resistance. As the pigment, an inorganic pigment and an organic pigment can both be used.

Examples of the inorganic pigment include carbon blacks such as furnace black, lamp black, acetylene black, and channel black, iron oxide, titanium oxide, and the like.

Examples of the organic pigment include an azo pigment such as an insoluble azo pigment, a condensed azo pigment, an azo lake pigment, or a chelate azo pigment, a polycyclic pigment such as a phthalocyanine pigment, a perylene pigment, a perinone pigment, an anthraquinone pigment, a quinacridone pigment, a dioxane pigment, a thioindigo pigment, an isoindolinone pigment, a quinophthalone pigment, a nitro pigment, and a nitroso pigment.

The pigments as described above may be used singly or in a combination of two or more kinds thereof.

A colorant content in the photo-curable ink (the same applying to the other second inks) is not particularly limited, and is preferably about 0.1 mass % or higher and 10 mass % or lower, and more preferably about 0.5 mass % or higher and 5 mass % or lower.

In addition, in a case where the photo-curable ink (the same applies to other second inks) is an ink for droplet ejection, an average particle size of the colorant is preferably about 10 nm or larger and 500 nm or smaller, more preferably about 25 nm or larger and 200 nm or smaller, and still more preferably about 50 nm or larger and 100 nm or smaller. In this case, the ejection stability, the dispersion stability, or the like of the second ink can be improved, and the print layer (image) 3 having high image quality can be formed. Here, the average particle size means a grain size (D50) at 50% of a volume integrated value in a grain size distribution obtained by a laser diffraction/scattering method.

In addition, the photo-curable ink may further contain a photopolymerization accelerator, a photopolymerization inhibitor, or the like, in addition to a solvent, a photopolymerization initiator, a surfactant, an antiseptic agent, an antifungal agent, a pH adjuster, a viscosity modifier, or a dispersant similar to those described in the first ink.

### <<Water-Based Ink>>

The water-based ink preferably contains at least a water-soluble compound, a colorant, and a solvent.

As the water-soluble compound, the same compounds as those described in the first ink can be used. In the case of the water-based ink, a water-soluble compound content in the water-based ink is preferably about 1 mass % or higher and 20 mass % or lower, and more preferably about 5 mass % or higher and 10 mass % or lower.

In addition, as the colorant, the same colorants as described in the photo-curable ink can be used.

Further, as the solvent, the same compound (a solvent or a dispersion medium) as described in the first ink can be used. Among the above-described substances, water and at least one of alcohols and glycol ethers are preferably used in a combination for the solvent.

In addition, the pH of the water-based ink may be adjusted by adding an alkali to the water-based ink.

As such an alkali, an inorganic alkali and an organic alkali can both be used.

Examples of the inorganic alkali include sodium hydroxide, potassium hydroxide, sodium carbonate, sodium silicate, and sodium metasilicate.

Examples of the organic alkali include ammonia, ethylamine, n-propylamine, diethylamine, diethylaminoethanol, di-n-propylamine, triethylamine, N-methyldiethylamine, dimethylethanolamine, triethanolamine, tetramethylammonium hydroxide, and tetraethylammonium hydroxide.

An alkali content in the water-based ink is preferably about 0.05 mass % or higher and 1 mass % or lower, and more preferably about 0.1 mass % or higher and 0.5 mass % or lower. The water-based ink may further contain a surfactant, an antiseptic agent, an antifungal agent, a viscosity modifier, a dispersant, or the like similar to those described in the first ink.

### <<Solvent Ink>>

The solvent ink preferably contains at least a resin, a colorant, and a solvent.

Examples of the resin include a vinyl-based resin (a vinyl acetate-based resin, a vinyl chloride-based resin, or the like), a urethane-based resin, an ester-based resin, an acrylic-based resin, a styrene-based resin, a butadiene-based resin, a styrene-butadiene-based resin, an acrylic styrene-based resin, and an acrylic silicone-based resin.

Among the resins, the vinyl-based resin is preferable as the resin. By using the solvent ink containing the vinyl-based resin, the adhesion between the print layer 3 to be formed and the base layer 2 can be sufficiently enhanced while high wettability of the second ink to the base layer 2 is maintained.

A resin content in the solvent ink is preferably about 0.1 mass % or higher, more preferably about 0.5 mass % or higher and 10 mass % or lower, and still more preferably about 1 mass % or higher and 5 mass % or lower. When the resin content in the solvent ink falls within the above range, the print layer 3 having a better appearance can be formed.

As the colorant, the same colorants as described in the photo-curable ink can be used.

In addition, as the solvent, the same compound (a solvent or a dispersion medium) as described in the first ink can be used. Among the above-described substances, at least one of glycol ethers and lactones are preferably used for the solvent.

The solvent ink may further contain a surfactant, an antiseptic agent, an antifungal agent, a pH adjuster, a viscosity modifier, a dispersant, or the like similar to those described in the first ink.

A coating film (liquid coating film) of the second ink supplied to the upper surface of the base layer 2 is dried, thereby solidifying a solid component contained in the second ink to obtain a dry coating film. This drying can be performed by natural drying, reduced-pressure drying, blow drying, heat drying, or the like. In addition, drying may be performed by combining two or more drying methods. Further, the same method as the method of drying the coating film of the first ink may be used.

The print layer 3 is obtained by performing a heat treatment on the dry coating film.

A heat treatment temperature is not particularly limited, and is preferably about 40° C. or higher and 120° C. or lower, and more preferably about 60° C. or higher and 100° C. or lower.

A heat treatment time is also not particularly limited, and is preferably about 5 minutes or longer and 24 hours or shorter, and more preferably about 10 minutes or longer and 20 hours or shorter.

In addition, in a case where the second ink is a photo-curable ink, the liquid coating film or the dry coating film can be irradiated with an ultraviolet ray (active energy ray).

Note that a condition for the ultraviolet irradiation can be set in the same manner as a condition for the ultraviolet irradiation for forming the base layer 2.

A thickness of the liquid coating film which becomes the print layer 3 is not particularly limited, and is preferably about 1 μm or larger and 50 μm or smaller, and more preferably about 10 μm or larger and 25 μm or smaller. The print layer 3 having such a thickness can maintain sufficient strength.

The second ink to be used is appropriately selected based on a constituent material, a front surface state, or the like of the base layer 2 (first ink) by reflecting wettability of the second ink to the upper surface of the base layer 2, an adhesion of the print layer 3 to be formed to the base layer 2, or the like.

The viscosity of the second ink at room temperature (25° C.) is preferably about 20 mPa·s or lower, and more preferably about 3 mPa·s or higher and 15 mPa·s or lower. In this case, it is easy to form the uniform print layer 3 having a uniform thickness.

When the base material 1 is viewed in a normal direction of the upper surface (front surface), the print layer 3 is preferably formed within a region of the base layer 2, that is, the base layer 2 preferably has a size to the extent that the print layer 3 is encompassed (see FIGS. 2(a) and 2(b)). This enables the print layer 3 to stably adhere to the base material 1 with the base layer 2 interposed therebetween.

In FIG. 2(b), a central print layer 3a is formed on an inner side of a region of the central base layer 2a, and an outer peripheral print layer 3b is formed on an inner side of the region of each outer peripheral base layer 2b. That is, an outer edge portion of the central base layer 2a is exposed from the central print layer 3a, and an outer edge portion of each outer peripheral base layer 2b is exposed from each outer peripheral print layer 3b.

### <Print Quality Checking Step S3>

In the print quality checking step S3, a quality of the print layer 3 is checked.

The quality of the print layer 3 is appropriately set depending on a desired print quality, thus not particularly limited, and preferably is at least one selected from cracking, smearing, cloudiness, and stickiness.

Examples of quality check criteria of the print layer 3 include visual observation, palpation observation, image analysis using an imaging element (CCD camera or the like), a surface roughness measurement test, a tape peeling test, a rubbing wear test, a scratch hardness test, and a pencil hardness test. Only one of these methods may be used, or two or more of these methods may be used in a combination thereof.

### <Coating Layer Formation Determining Step S4>

In the coating layer formation determining step S4, whether to form the coating layer 4 (“YES” in FIG. 1) or to remove the print layer 3 together with the base layer 2 from the base material 1 (“NO” in FIG. 1) is determined depending on the quality of the print layer 3 checked in the print quality checking step S3.

Specifically, in the coating layer formation determining step S4, if the quality of the print layer 3 satisfies the above criteria, it is determined to form the coating layer 4 (YES), and the process proceeds to the coating layer forming step S5.

Meanwhile, in the coating layer formation determining step S4, if the quality of the print layer 3 does not satisfy the above criteria, it is determined not to form the coating layer 4 (NO), and the process proceeds to the print layer/base layer removing step S6.

### <Coating Layer Forming Step S5>

In the coating layer forming step S5, the coating layer 4 covering the print layer 3 is formed.

The coating layer 4 is formed by supplying a third ink (coating layer forming ink) to cover the print layer 3. A method of supplying the third ink is not particularly limited, and examples thereof include a droplet ejection method (inkjet method), a bar coating method, a wire bar coating method, a spin coating method, a casting method, a micro gravure coating method, a gravure coating method, a roll coating method, a dip coating method, a spray coating method, a screen printing method, a flexographic printing method, and an offset printing method.

Among these methods, the droplet ejection method is preferable as the method of supplying the third ink. That is, the coating layer 4 is suitably formed by the droplet ejection method. The droplet ejection method makes it easy to accurately form the coating layer 4 having a shape corresponding to the shapes of the base layer 2 and the print layer 3. In addition, the droplet ejection method enables the coating layer 4 having a fine shape to be accurately formed.

The third ink preferably contains at least monofunctional (meth)acrylate, polyfunctional (meth)acrylate, and a photopolymerization initiator.

As the monofunctional (meth)acrylate and the polyfunctional (meth)acrylate, the same compounds as those described in the first ink or the second ink can be used.

In addition, as the photopolymerization initiator, the same compounds as those described in the first ink can be used.

The third ink may further contain a photopolymerization accelerator, a photopolymerization inhibitor, or the like, in addition to a solvent, a photopolymerization initiator, a surfactant, an antiseptic agent, an antifungal agent, a pH adjuster, a viscosity modifier, or a dispersant similar to those described in the first ink.

By using the third ink, the coating layer 4 having a high adhesion to the base material 1 can be formed.

A monofunctional (meth)acrylate content in the third ink is preferably about 30 mass % or higher and 80 mass % or lower, more preferably about 40 mass % or higher and 70 mass % or lower, and still more preferably about 50 mass % or higher and 60 mass % or lower.

A polyfunctional (meth)acrylate content in the third ink is preferably about 10 mass % or higher and 55 mass % or lower, more preferably about 20 mass % or higher and 45 mass % or lower, and still more preferably about 30 mass % or higher and 35 mass % or lower.

A photopolymerization initiator content in the third ink is preferably about 1 mass % or higher and 35 mass % or lower, more preferably about 5 mass % or higher and 25 mass % or lower, and still more preferably about 10 mass % or higher and 15 mass % or lower.

A coating film (liquid coating film) of the third ink supplied to cover the print layer 3 is dried, as necessary, thereby solidifying a solid component contained in the third ink to obtain a dry coating film.

This drying can be performed by a drying method such as natural drying, reduced-pressure drying, blow drying, heat drying, or the like. In addition, these drying methods may be randomly combined. Further, the same method as the method of drying the coating films of the first ink and the second ink may be used.

Subsequently, the dry coating film can be irradiated with an ultraviolet ray (active energy ray). The liquid coating film may be directly irradiated with the ultraviolet ray.

Note that a condition for the ultraviolet irradiation can be set in the same manner as a condition for the ultraviolet irradiation for forming the base layer 2.

A thickness of the liquid coating film which becomes the coating layer 4 is not particularly limited, and is preferably about 10 μm or larger and 60 μm or smaller, and more preferably about 20 μm or larger and 40 μm or smaller. The coating layer 4 having such a thickness can maintain sufficient strength.

The third ink to be used is appropriately selected based on a constituent materials, a front surface state, or the like of the base material 1 and the print layer 3 (second ink) by reflecting wettability of the third ink to the upper surface of the print layer 3, an adhesion of the coating layer 4 to be formed to the base layer 1 and the print layer 3, or the like.

The viscosity of the third ink at room temperature (25° C.) is preferably about 20 mPa·s or lower, and more preferably about 3 mPa·s or higher and 15 mPa·s or lower. In this case, it is easy to form the uniform coating layer 4 having a uniform thickness.

When the base material 1 is viewed in the normal direction of the upper surface (front surface), the coating layer 4 preferably has a size to the extent that the base layer 3 is encompassed (see FIGS. 3(a) and 3(b)). This enables the base layer 2 and the print layer 3 to stably adhere to the base material 1.

The coating layer 4 may include individual coating layers including a central coating layer 4a that coats the central base layer 2a and the central print layer 3a, and an outer peripheral coating layer 4a that coats the outer peripheral base layer 2b and the outer peripheral print layer 3b as illustrated in FIG. 3(a), or may be made of a collective coating layer that collectively coats the central base layer 2a, the central print layer 3a, the outer peripheral base layer 2b, and the outer peripheral print layer 3b as illustrated in FIG. 3(b).

In this case, particularly, it is preferable that the coating layer 4 be formed to have a higher adhesion to the base material 1 than that of the base layer 2 thereto by selecting a constituent material of the coating layer 4. This enables adhesive force of the base layer 2 and the print layer 3 to the base material 1 to be further enhanced.

As described above, the base layer 2, the print layer 3, and the coating layer 4 are sequentially formed on the base material 1, thereby obtaining a printed matter as a final product.

### <Print Layer/Base Layer Removing Step S6>

In the print layer/base layer removing step S6, the print layer 3 is removed together with the base layer 2 from the base material 1.

As described above, it is preferable that the base layer 2 be removed by at least one selected from contact with a solvent, ultraviolet irradiation, heating, and plasma treatment.

<<Contact with Solvent>>

The base layer 2 and the solvent can be brought into contact with each other by, for example, a method of immersing the base layer 2 (or the base material 1 on which the base layer 2 and the print layer 3 are formed) in a solvent (an immersion method), a method of applying the solvent to the base layer 2 (an application method), a method of spraying the solvent to the base layer 2 (a spray method), or the like. Of the methods, it is preferable that the base layer 2 be brought into contact with the solvent by the immersion method.

A temperature of the solvent is not particularly limited, and is preferably about 20° C. or higher and 70° C. or lower, more preferably about 30° C. or higher and 60° C. or lower, and still more preferably about 40° C. or higher and 50° C. or lower. When a solvent having such a temperature is used, the base layer 2 can be removed in a shorter time.

When the base layer 2 (or the base material 1 on which the base layer 2 and the print layer 3 are formed) is immersed in a solvent, it is preferable that at least one selected from irradiation with ultrasonic waves, heating, and swinging be performed. This makes it possible to promote the removal of the base layer 2 due to dissolution in the solvent.

In a case where irradiation is performed with the ultrasonic wave, a frequency of the ultrasonic wave is preferably about 10 kHz or higher and 100 kHz or lower, more preferably about 15 kHz or higher and 80 kHz or lower, and still more preferably about 30 kHz or higher and 60 kHz or lower.

An ultrasonic irradiation time is preferably about 1 minute or longer and 60 minutes or shorter, and more preferably about 5 minutes or longer and 45 minutes or shorter.

In the case of heating, a temperature of the solvent (base layer 2) is preferably about 30° C. or higher and 85° C. or lower, and more preferably about 40° C. or higher and 65° C. or lower.

The swinging can be performed by causing the base material 1 to reciprocate with respect to the solvent.

### <<Ultraviolet Irradiation>>

Conditions of the ultraviolet irradiation are not particularly limited since the conditions are appropriately set depending on a type of ultraviolet decomposable compound, or the like.

As examples of the conditions of the ultraviolet irradiation, the intensity of the ultraviolet ray is preferably about 10 mW/cm² or higher and 3,000 mW/cm² or lower, and more preferably about 20 mW/cm² or higher and 500 mW/cm² or lower.

In addition, an energy quantity of the ultraviolet ray is preferably about 100 mJ/cm² or higher and 20,000 mJ/cm² or lower, and more preferably about 200 mJ/cm² or higher and 10,000 mJ/cm² or lower.

### <<Heating>>

Heating conditions are not particularly limited since the heating conditions are appropriately set depending on a type of thermally decomposable compound, a type of resin having a Tg of about room temperature, a type of gas contained in thermally expandable particles, or the like.

As examples of the heating conditions, a heating temperature is preferably about 110° C. or higher and 170° C. or lower, and more preferably about 125° C. or higher and 150° C. or lower.

In addition, a heating time is preferably about 5 minutes or longer and 100 minutes or shorter, and more preferably about 10 minutes or longer and 60 minutes or shorter.

### <<Plasma Treatment>>

Conditions for the plasma treatment are also not particularly limited since the conditions are appropriately set depending on a type of plasma degradable compound or the like.

A process gas that can be used for generating plasma is not particularly limited, and examples thereof include a gas containing, as a main component, at least one of oxygen, nitrogen, argon, helium, or carbon fluoride. In particular, when a process gas containing argon or helium as a main component is used, an apparatus can be simplified, since plasma can be generated under a relatively low vacuum atmosphere or under atmospheric pressure.

A flow rate of the process gas is preferably about 10 sccm or higher and 500 sccm or lower, and more preferably about 50 sccm or higher and 400 sccm or lower.

A high frequency output (RF power) is preferably about 0.005 W/cm² or higher and 0.2 W/cm² or lower, and more preferably about 0.05 W/cm² or higher and 0.1 W/cm² or lower.

A time (treatment time) in the plasma treatment is preferably about 60 seconds or longer and 600 seconds or shorter, and more preferably about 180 seconds or longer and 360 seconds or shorter.

A temperature of the atmosphere (atmosphere temperature) in the plasma treatment is preferably about 0° C. or higher and 100° C. or lower, and more preferably about 20° C. or higher and 50° C. or lower.

The atmosphere in the plasma treatment is preferably the relatively low vacuum atmosphere or the atmospheric pressure.

In this manner, in the print layer/base layer removing step S6, the print layer 3 is removed together with the base layer 2 from the base material 1.

Then, the base material 1 from which the print layer 3 has been removed together with the base layer 2 again proceeds to the base layer forming step S1, and is subjected to the print layer forming step S2, the print quality checking step S3, and the coating layer forming step S5 or the print layer/base layer removing step S6 as a post-processing step.

The method for manufacturing printed matter described above enables the print layer 3 to be removed together with the base layer 2, and enables the print layer 3 to be formed again using the same base material 1, even if the quality of the print layer 3 does not satisfy predetermined criteria, thereby enabling the base material 1 to be effectively used without wasting the base material 1. In particular, the method is significantly advantageous in the case of manufacturing the base material 1 made of a valuable material or single-item printed matter. In addition, the printed matter in which the quality of the print layer 3 satisfies the predetermined criteria has the coating layer 4, thereby enabling the print layer 3 to be prevented from peeling off, and also enabling deterioration of the quality of the print layer 3 to be curbed.

In a case where printed matter as a final product is used for a long period of time and the quality of the print layer or the performance of the coating layer 4 deteriorates, the final product may need to be removed from the base material 1 for disposal. That is, after the coating layer 4 covering the print layer 3 is formed, the print layer 3 may need to be removed. In this case, it is preferable to form a penetration portion penetrating the coating layer 4 in a thickness direction. After the penetration portion is formed, for example, a solvent capable of dissolving the base layer 2 infiltrates through the penetration portion, thereby enabling the base layer 2, the print layer 3, and the coating layer 4 to be removed from the base material 1. This enables the base material 1 to be reused.

Note that, even in a case where a method other than the contact with a solvent is used for removing the base layer 2, the strength of the coating layer 4 can be decreased by forming the penetration portion, thus making it easy to remove the base layer 2, the print layer 3, and the coating layer 4 from the base material 1.

Examples of the penetration portion include a continuously formed notch, intermittently formed notches (perforations), and a through-hole (a needle hole, a punch hole, or the like).

### MODIFICATION EXAMPLE

A modification example of the method for manufacturing printed matter will be described.

Hereinafter, a method for manufacturing printed matter according to the modification example will be described, and differences from the method for manufacturing printed matter of the above-described embodiment will be mainly described, and the description of similar parts will be omitted.

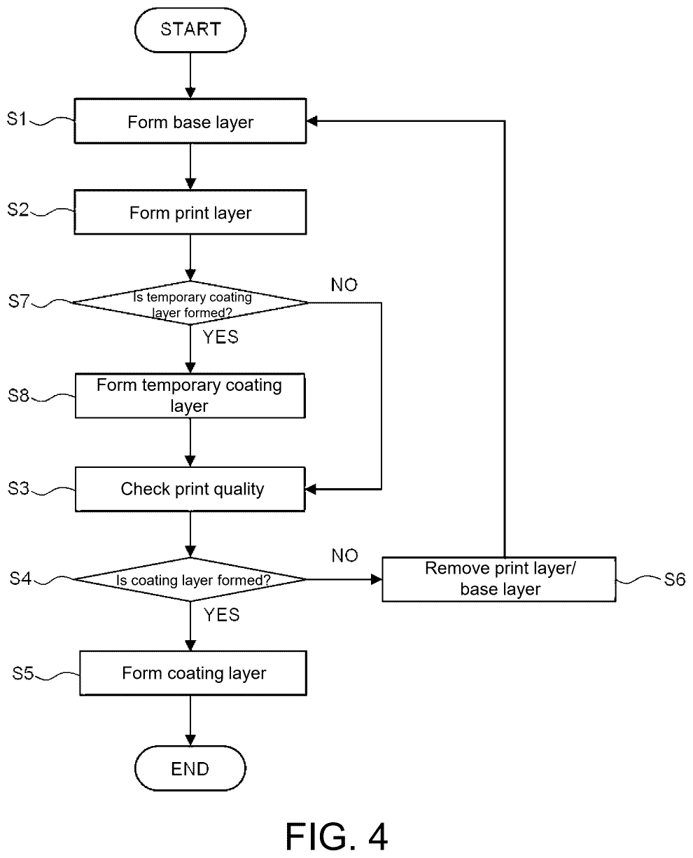

FIG. 4 is a flowchart of a method for manufacturing printed matter according to a modification example.

As illustrated in FIG. 4, the method for manufacturing printed matter according to the modification example further includes a temporary coating layer formation determining step S7 and a temporary coating layer forming step S8 between the print layer forming step S2 and the print quality checking step S3, and the other steps are similar to those of the method for manufacturing printed matter of the above-described embodiment.

Hereinafter, the temporary coating layer formation determining step S7 and the temporary coating layer forming step S8 will be described.

### <Temporary Coating Layer Formation Determining Step S7>

In the temporary coating layer formation determining step S7, it is determined whether or not to form a temporary coating layer that covers the print layer 3.

Specifically, whether or not to form the temporary coating layer is determined based on, for example, a degree of adhesion (affinity) between the print layer 3 and the base layer 2, a degree of easiness of degradation (oxidation or the like) of the print layer 3, and the like.

In a case where it is determined that the temporary coating layer needs to be formed (“YES” in FIG. 4), the process proceeds to the temporary coating layer forming step S8. In a case where it is determined that the temporary coating layer does not need to be formed (“NO” in FIG. 4), the process proceeds to the print quality checking step S3.

### <Temporary Coating Layer Forming Step S8>

In the temporary coating layer forming step S8, the temporary coating layer that covers the print layer 3 is formed.

This temporary coating layer has, for example, the following functions.
I: A function of maintaining the shape of the print layer 3 until the coating layer 4 is formed
II: A function of preventing the print layer 3 from peeling off from the base material 1 until the coating layer 4 is formed
III: A function of preventing the quality of the print layer 3 from deteriorating until the coating layer 4 is formed
IV: A function of assisting removal processing of the print layer 3 or the like from base material 1 when the base material 1 is reused after the printed matter that is a final product is used
V: A function of checking a degree of completion, a state of a design, or the like when the coating layer 4 is formed.

The temporary coating layer is formed by supplying a fourth ink (temporary coating layer forming ink) to cover the print layer 2. A method of supplying the fourth ink is not particularly limited, and examples thereof include a droplet ejection method (inkjet method), a bar coating method, a wire bar coating method, a spin coating method, a casting method, a micro gravure coating method, a gravure coating method, a roll coating method, a dip coating method, a spray coating method, a screen printing method, a flexographic printing method, and an offset printing method.

Among these methods, the droplet ejection method is preferable as the method of supplying the fourth ink. That is, the temporary coating layer is suitably formed by the droplet ejection method. The droplet ejection method makes it easy to accurately form the temporary coating layer having a shape corresponding to the shape of the print layer 3. In addition, the droplet ejection method enables the temporary coating layer having a fine shape to be accurately formed.

As the fourth ink, at least one selected from the first ink that can be used for forming the base layer 2, the third ink that can be used for forming the coating layer 4, and the like can be used.

A forming condition of the temporary coating layer can be set in the same manner as, for example, a forming conditions described for the base layer 2, a forming condition described for the coating layer 4, or the like.

By the method for manufacturing printed matter according to such a modification example, the same operations/effects as those of the method for manufacturing printed matter of the above-described embodiment can be obtained. In particular, since the temporary coating layer that covers the print layer 3 is formed as necessary, for example, cracking, smearing, cloudiness, stickiness, and the like of the print layer 3 are less likely to occur, and a labor hour for forming the print layer 3 again (the coating layer forming step S4: NO) can be reduced.

Therefore, it is possible to manufacture printed matter having the print layer 3 with less variations in quality regardless of the constituent material of the print layer 3.

The methods for manufacturing printed matter according to the present embodiment and the modification example have the following configurations.

(1) The method for manufacturing printed matter includes
a base layer forming step; a print layer forming step; a print quality checking step; and a post-processing step.

In the base layer forming step, the base layer which is removable from the base material is formed on the front surface of the base material.

In the print layer forming step, the print layer is formed on the surface of the base layer on the side opposite to the base material.

In the print quality checking step, the quality of the print layer is checked.

In the post-processing step, the coating layer that coats the print layer is formed or the print layer is removed together with the base layer from the base material depending on the quality of the print layer.

(2) The method for manufacturing printed matter as set forth in (1), in which the base layer includes the first base layer formed on the base material side and the second base layer which is formed on the first base layer on the side opposite to the base material and has a higher adhesion to the print layer than an adhesion of the first base layer to the print layer.

(3) The method for manufacturing printed matter as set forth in (2), in which the first base layer has a higher adhesion to the base material than an adhesion of the second base layer to the base material.

(4) The method for manufacturing printed matter as set forth in any one of (1) to (3), in which the base layer is formed by the droplet ejection method or the bar coating method.

(5) The method for manufacturing printed matter as set forth in any one of (1) to (4), in which the base layer has the size to the extent that the print layer is encompassed when the base material is viewed in the normal direction of the front surface.

(6) The method for manufacturing printed matter as set forth in any one of (1) to (5), in which the print layer is formed by the droplet ejection method.

(7) The method for manufacturing printed matter as set forth in any one of (1) to (6), in which the coating layer is formed by the droplet ejection method.

(8) The method for manufacturing printed matter as set forth in any one of (1) to (7), in which the coating layer has the size to the extent that the base layer is encompassed when the base material is viewed in the normal direction of the front surface.

(9) The method for manufacturing printed matter as set forth in any one of (1) to (8), in which the coating layer has a higher adhesion to the base material than an adhesion of the base layer to the base material.

(10) The method for manufacturing printed matter as set forth in any one of (1) to (9), in which the quality of the print layer is at least one selected from cracking, smearing, cloudiness, and stickiness.

(11) The method for manufacturing printed matter as set forth in any one of (1) to (10), in which the base layer is removed by at least one selected from contact with the solvent, ultraviolet irradiation, heating, and plasma treatment.

(12) The method for manufacturing printed matter as set forth in (11), in which the contact of the base layer with the solvent is performed by the method of immersing the base layer in the solvent.

(13) The method for manufacturing printed matter as set forth in (12), in which, when the base layer is immersed in the solvent, at least one selected from ultrasonic irradiation, heating, and swinging is performed.

(14) The method for manufacturing printed matter as set forth in any one of (1) to (13), further including the temporary coating layer forming step between the print layer forming step and the print quality checking step, in which, in the temporary coating layer forming step, the temporary coating layer that covers the print layer is formed.

(15) The method for manufacturing printed matter as set forth in any one of (1) to (14), in which the base material from which the print layer has been removed together with the base layer is subjected to the base layer forming step, the print layer forming step, the print quality checking step, and the post-processing step again.

(16) The method for manufacturing printed matter as set forth in any one of (1) to (15), in which, in a case where the coating layer covering the print layer is formed, and then the print layer needs to be removed, the penetration portion penetrating the coating layer in the thickness direction is formed.

The embodiment and the modification example according to the present invention have been described above, but are provided as examples, and the scope of the invention is not limited thereto at all. The novel embodiment can be implemented in various other aspects, and various omissions, substitutions, and modifications can be made without departing from the gist of the invention. The embodiment and modifications thereof are included in the scope and gist of the invention and are included in the invention described in the claims and the equivalent scope thereof.

### EXAMPLES

Hereinafter, the present invention will be described more specifically with reference to examples, but the present invention is not limited to these examples.

### 1. Material Preparation

First, the following materials were prepared.

### <Base Material>

Base material 1: PET film (“Lumirror S10” manufactured by TORAY INDUSTRIES, INC.)
Base material 2: PET film (“Gelpoly 50UV-IJ” manufactured by PANAC Corporation)·
Base material 3: PET film (“HK-31WF” manufactured by Higashiyama Film Co., Ltd.)
Base material 4: PET film (“U292W” manufactured by TOYOBO CO., LTD.)

### <First Ink (Base Layer Forming Ink)>

First ink 1: 3D support material (“SW-100” manufactured by MIMAKI ENGINEERING CO., LTD.)
First ink 2: Polyallylamine-containing ink (“PPA-01 (molecular weight: 1,600)” manufactured by NITTOBO MEDICAL CO., LTD.)
First ink 3: Polyallylamine-containing ink (“PPA-03 (molecular weight: 3,000)” manufactured by NITTOBO MEDICAL CO., LTD.)

### <Second Ink (Print Layer Forming Ink)>

Second ink 1: Water-based ink (manufactured by MIMAKI ENGINEERING CO., LTD.)
Second ink 2: Photo-curable ink (“LUS-170” manufactured by MIMAKI ENGINEERING CO., LTD.)
Second ink 3: Solvent ink (“SS21” manufactured by MIMAKI ENGINEERING CO., LTD.)

### <Third Ink (Coating Layer Forming Ink)>

Third ink 1: Photo-curable ink (“TCU-100” manufactured by MIMAKI ENGINEERING CO., LTD.).
Third ink 2: Photo-curable ink (“LH-100 CL” manufactured by MIMAKI ENGINEERING CO., LTD.)

### 2-1. Formation of Base Layer and Print Layer

A size of the base material used below was 12 mm×12 mm.

### (Sample No. 1A)

### <Base Layer Forming Step>

First, the first ink 1 was supplied to the upper surface of the base material 1 by the bar coating method to form a liquid coating film having a thickness of 2 μm.

Next, the liquid coating film was irradiated with an ultraviolet ray at room temperature (25° C.). In this manner, the liquid coating film was cured to form the base layer. Note that the intensity of the ultraviolet ray was set to 466 mW/cm², and the energy quantity of the ultraviolet ray was set to 336 mJ/cm².

### <Print Layer Forming Step>

First, droplets of the second ink 1 were ejected on the upper surface of the base layer by the inkjet method (droplet ejection method) to form a liquid coating film having a thickness of 14 to 42 μm. Note that a temperature of a platen heater of an inkjet apparatus was set to 60° C.

Next, the liquid coating film was subjected to the heat treatment in the air at 80° C. for ten minutes. In this manner, the liquid coating film was solidified to form the print layer.

Note that, when the base material 1 was viewed in the normal direction of the upper surface, the shape and the size of the base layer were set to match the shape and the size of the print layer.

### (Sample No. 2A)

A base layer and a print layer were formed in the same manner as in Sample No. 1A except that the thickness of the liquid coating film of the first ink 1 was changed to 10 μm.

### (Sample No. 3A)

A base layer and a print layer were formed in the same manner as in Sample No. 1A except that the base material 2 was used instead of the base material 1.

### (Sample No. 4A)

A base layer and a print layer were formed in the same manner as in Sample No. 3A except that the thickness of the liquid coating film of the first ink 1 was changed to 10 μm.

### (Sample No. 5A)

### <Base Layer Forming Step>

First, the first ink 1 was supplied to an upper surface of the base material 3 by the bar coating method to form a liquid coating film having a thickness of 0.1 μm.

Next, the liquid coating film was irradiated with an ultraviolet ray at room temperature (25° C.). In this manner, the liquid coating film was cured to form the base layer. Note that the intensity of the ultraviolet ray was set to 466 mW/cm², and the energy quantity of the ultraviolet ray was set to 336 mJ/cm².

### <Print Layer Forming Step>

First, droplets of the second ink 2 were ejected on the upper surface of the base layer by the inkjet method (droplet ejection method) to form a liquid coating film having a thickness of 23 to 69 μm. Note that the platen heater of the inkjet apparatus was not operated.

Next, the liquid coating film was irradiated with an ultraviolet ray at room temperature (25° C.). In this manner, the liquid coating film was cured to form the base layer. Note that the intensity of the ultraviolet ray was set to 370 mW/cm², and the energy quantity of the ultraviolet ray was set to 710 mJ/cm².

Note that, when the base material 3 was viewed in the normal direction of the upper surface, the shape and the size of the base layer were set to match the shape and the size of the print layer.

### (Sample No. 6A)

A base layer and a print layer were formed in the same manner as in Sample No. 5A except that the thickness of the liquid coating film of the first ink 1 was changed to 13.7 μm.

### (Sample No. 7A)

A base layer and a print layer were formed in the same manner as in Sample No. 5A except that the base material 4 was used instead of the base material 3.

### (Sample No. 8A)

A base layer and a print layer were formed in the same manner as in Sample No. 7A except that the thickness of the liquid coating film of the first ink 1 was changed to 13.7 μm.

### (Sample No. 9A)

### <Base Layer Forming Step>

First, the first ink 1 was supplied to an upper surface of the base material 3 by the bar coating method to form a liquid coating film having a thickness of 0.1 μm.

Next, the liquid coating film was irradiated with an ultraviolet ray at room temperature (25° C.). In this manner, the liquid coating film was cured to form the base layer. Note that the intensity of the ultraviolet ray was set to 466 mW/cm², and the energy quantity of the ultraviolet ray was set to 366 mJ/cm².

### <Print Layer Forming Step>

First, droplets of the second ink 3 were ejected on the upper surface of the base layer by the inkjet method (droplet ejection method) to form a liquid coating film having a thickness of 19 to 57 μm. Note that a temperature of a platen heater of an inkjet apparatus was set to 45° C.

Next, the liquid coating film was subjected to the heat treatment in the air at 60° C. for 18 hours. In this manner, the liquid coating film was solidified to form the print layer.

Note that, when the base material 3 was viewed in the normal direction of the upper surface, the shape and the size of the base layer were set to match the shape and the size of the print layer.

### (Sample No. 10A)

A base layer and a print layer were formed in the same manner as in Sample No. 9A except that the thickness of the liquid coating film of the first ink 1 was changed to 13.7 μm.

### (Sample No. 11A)

A base layer and a print layer were formed in the same manner as in Sample No. 9A except that the base material 2 was used instead of the base material 3.

### (Sample No. 12A)

A base layer and a print layer were formed in the same manner as in Sample No. 11A except that the thickness of the liquid coating film of the first ink 1 was changed to 13.7 μm.

### (Sample No. 1B)

### <Base Layer Forming Step>

First, the first ink 2 was supplied to the upper surface of the base material 1 by the bar coating method to form a liquid coating film having a thickness of 2 μm.

### <Print Layer Forming Step>

First, droplets of the second ink 1 were ejected on an upper surface of the liquid coating film by the inkjet method (droplet ejection method) to form (layer) a liquid coating film having a thickness of 14 to 42 μm. Note that the platen heater of the inkjet apparatus was not operated.

Next, the layered liquid coating films were subjected to the heat treatment in the air at 80° C. for ten minutes. In this manner, the layered liquid coating films were solidified to form the base layer and the print layer.

Note that, when the base material 1 was viewed in the normal direction of the upper surface, the shape and the size of the base layer were set to match the shape and the size of the print layer.

### (Sample No. 2B)

A base layer and a print layer were formed in the same manner as in Sample No. 1B except that the thickness of the liquid coating film of the first ink 2 was changed to 10 μm.

### (Sample No. 3B)

A base layer and a print layer were formed in the same manner as in Sample No. 1B except that the base material 2 was used instead of the base material 1.

### (Sample No. 4B)

A base layer and a print layer were formed in the same manner as in Sample No. 3B except that the thickness of the liquid coating film of the first ink 2 was changed to 10 μm.

### (Sample No. 5B)

### <Base Layer Forming Step>

First, the first ink 3 was supplied to the upper surface of the base material 1 by the bar coating method to form a liquid coating film having a thickness of 2 μm.

### <Print Layer Forming Step>

First, droplets of the second ink 1 were ejected on an upper surface of the liquid coating film by the inkjet method (droplet ejection method) to form (layer) a liquid coating film having a thickness of 14 to 42 μm. Note that the platen heater of the inkjet apparatus was not operated.

Next, the layered liquid coating films were subjected to the heat treatment in the air at 80° C. for ten minutes. In this manner, the layered liquid coating films were solidified to form the base layer and the print layer.

Note that, when the base material 1 was viewed in the normal direction of the upper surface, the shape and the size of the base layer were set to match the shape and the size of the print layer.

### (Sample No. 6B)

A base layer and a print layer were formed in the same manner as in Sample No. 5B except that the thickness of the liquid coating film of the first ink 3 was changed to 10 μm.

### (Sample No. 7B)

A base layer and a print layer were formed in the same manner as in Sample No. 5B except that the base material 2 was used instead of the base material 1.

### (Sample No. 8B)

A base layer and a print layer were formed in the same manner as in Sample No. 7B except that the thickness of the liquid coating film of the first ink 3 was changed to 10 μm.

### (Sample No. 9B)

### <Base Layer Forming Step>

First, the first ink 2 was supplied to the upper surface of the base material 1 by the bar coating method to form a liquid coating film having a thickness of 2 μm.

Next, the liquid coating film was subjected to the heat treatment in the air at 80° C. for ten minutes. In this manner, the liquid coating film was solidified to form the base layer.

### <Print Layer Forming Step>

First, droplets of the second ink 1 were ejected on the upper surface of the base layer by the inkjet method (droplet ejection method) to form a liquid coating film having a thickness of 14 to 42 μm. Note that a temperature of a platen heater of an inkjet apparatus was set to 60° C.

Next, the layered liquid coating films were subjected to the heat treatment in the air at 80° C. for ten minutes. In this manner, the layered liquid coating films were solidified to form the base layer and the print layer.

Note that, when the base material 1 was viewed in the normal direction of the upper surface, the shape and the size of the base layer were set to match the shape and the size of the print layer.

### (Sample No. 10B)

A base layer and a print layer were formed in the same manner as in Sample No. 9B except that the thickness of the liquid coating film of the first ink 2 was changed to 10 μm.

### 2-2. Evaluation

### <Quality Check of Print Layer>

A state (image quality) of the upper surface of the print layer was evaluated by visual observation and palpation observation.

### <X-Cut Test>

A plurality of sections were formed by making cuts in a checkerboard pattern in the print layer, and then a tape was bonded to the print layer. Thereafter, the tape peeled off from the print layer, and the state of the upper surface of the print layer was checked.

Note that, in the following Table, a ratio of the sections which did not peel off but remain on the base material (a case of no peeling-off is written as “10”) is described, and a case where the print layer is sticky and the X-cut test is not performed is described as “sticky”.

### <Claw Rubbing Test>

The upper surface of the print layer was rubbed ten times with a claw and was evaluated in accordance with the following criteria.
∘: Peeling-off does not occur.
Δ: Peeling-off occurs when strong rub is performed.
x: Peeling-off occurs easily.

### <Water Immersion Test

A sample and water (25° C.) were put in a small bottle and shaken lightly, and then a degree of peeling-off of the print layer was observed. Note that, in a case where an ultrasonic wave was applied, a frequency thereof was set to 38 kHz.

The results thereof are illustrated in Tables 1 and 2 below.

TABLE 1

| Sample No. | | | 1A | 2A | 3A | 4A | 5A | 6A |
|---|---|---|---|---|---|---|---|---|
| Base | First ink | | 1 | 1 | 1 | 1 | 1 | 1 |
| layer | wet thickness | | 2 | 10 | 2 | 10 | 0.1 | 13.7 |
| | [μm] | | | | | | | |
| | Curing or | | Ultraviolet | Ultraviolet | Ultraviolet | Ultraviolet | Ultraviolet | Ultraviolet |
| | solidification | | irradiation | irradiation | irradiation | irradiation | irradiation | irradiation |
| Print | Second ink | | 1 | 1 | 1 | 1 | 2 | 2 |
| layer | Platen heater | | 60 | 60 | 60 | 60 | OFF | OFF |
| | [° C.] | | | | | | | |
| | Curing or | | 80° C. | 80° C. | 80° C. | 80° C. | Ultraviolet | Ultraviolet |
| | solidification | | 10 min | 10 min | 10 min | 10 min | irradiation | irradiation |
| Base material | | | 1 | 1 | 2 | 2 | 3 | 3 |
| | Image | Cracking | Observed | Observed | Observed | Observed | OFF | OFF |
| | quality | Smearing | OFF | OFF | OFF | OFF | OFF | OFF |
| Evaluation | X-cut test | | Sticky | Sticky | Sticky | Sticky | 6 | 0 |
| | [Ratio] | | | | | | | |
| | Claw friction test | | x | x | x | x | Δ | Δ |
| | Water | Immediately | | | | | | |
| | immersion | after | Peeling- | Peeling- | No | Peeling-off | Peeling-off | Peeling-off |
| | test | formation | off to 100% | off to 100% | peeling-off | to 100% | to 100% | to 100% |
| | | Ultra | — | — | Peeling-off | — | — | — |
| | | sonic | | | to 50% | | | |
| | | wave for | | | | | | |
| | | 2 min | | | | | | |
| | | Ultra | — | — | Peeling-off | — | — | — |
| | | sonic | | | to approximately | | | |
| | | wave for | | | 100% | | | |
| | | 30 min | | | | | | |

| Sample No. | | 7A | 8A | 9A | 10A | 11A | 12A |
|---|---|---|---|---|---|---|---|
| Base | First ink | 1 | 1 | 1 | 1 | 1 | 1 |
| layer | wet thickness | 0.1 | 13.7 | 0.1 | 13.7 | 0.1 | 13.7 |
| | [μm] | | | | | | |
| | Curing or | Ultraviolet | Ultraviolet | Ultraviolet | Ultraviolet | Ultraviolet | Ultraviolet |
| | solidification | irradiation | irradiation | irradiation | irradiation | irradiation | irradiation |
| Print | Second ink | 2 | 2 | 3 | 3 | 3 | 3 |
| layer | Platen heater | OFF | OFF | 45 | 45 | 45 | 45 |
| | [° C.] | | | | | | |
| | Curing or | Ultraviolet | Ultraviolet | 60° C. | 60° C. | 60° C. | 60° C. |
| | solidification | irradiation | irradiation | 18 h | 18 h | 18 h | 18 h |

| | | | | | | |
|---|---|---|---|---|---|---|
| Base material | 4 | 4 | 3 | 3 | 2 | 2 |

| | | | | | | | |
|---|---|---|---|---|---|---|---|
| Image | Cracking | OFF | OFF | OFF | OFF | OFF | OFF |
| quality | Smearing | OFF | OFF | Observed | Observed | Observed | Observed |

| | | | | | | | |
|---|---|---|---|---|---|---|---|
| Evaluation | X-cut test | 0 | 0 | Sticky | Sticky | Sticky | Sticky |
| | [Ratio] | | | | | | |
| | Claw friction test | Δ | Δ | x | x | x | x |

| | | | | | | | |
|---|---|---|---|---|---|---|---|
| Water | Immediately | | | | | | |
| immersion | after | Peeling-off | Peeling-off | Peeling-off | Peeling-off | Peeling-off | Peeling-off |
| test | formation | to 100% | to 100% | to 100% | to 100% | to 100% | to 100% |
| | Ultra | — | — | — | — | — | — |
| | sonic | | | | | | |
| | wave for | | | | | | |
| | 2 min | | | | | | |
| | Ultra | — | — | — | — | — | — |
| | sonic | | | | | | |
| | wave for | | | | | | |
| | 30 min | | | | | | |

As illustrated in Table 1, it was found that in a case where the base layer was formed using the 3D support material, compatibility of the base layer with the print layer formed of the photo-curable ink was favorable.

In addition, it was found that in a case where the base layer is formed using the 3D support material, the print layer (base layer) can easily peel off by being immersed in water regardless of the type of second ink used for forming the print layer.

Further, in a case where the base layer was formed using the 3D support material, the strength of the print layer was less likely to be affected when the thickness of the base layer was thin. It could also be checked that the easiness of the peeling-off by being immersed in water did not depend on the thickness of the base layer.

Note that, in sample Nos. 1A to 4A and 9A to 12A, the print layer was sticky and had low strength. In such cases, it is considered effective to form the temporary coating layer before forming the coating layer.

TABLE 2

| Sample No. | | | 1B | 2B | 3B | 4B | 5B |
|---|---|---|---|---|---|---|---|
| Base | First ink | | 2 | 2 | 2 | 2 | 3 |
| layer | wet thickness [μm] | | 2 | 10 | 2 | 10 | 2 |
| | Curing or | | OFF | OFF | OFF | OFF | OFF |
| | solidification | | | | | | |
| Print | Second ink | | 1 | 1 | 1 | 1 | 1 |
| layer | Platen heater [° C.] | | OFF | OFF | OFF | OFF | OFF |
| | Curing or | | 80° C. | 80° C. | 80° C. | 80° C. | 80° C. |
| | solidification | | 10 min | 10 min | 10 min | 10 min | 10 min |
| Base material | | | 1 | 1 | 2 | 2 | 1 |
| Evaluation | Image | Cloudiness | Observed | Observed | Observed | Observed | Observed |
| | quality | | | | | | |
| | X-cut test [Ratio] | | 10 | 10 | 10 | 10 | 10 |
| | Claw friction test | | ∘ | ∘ | ∘ | ∘ | ∘ |
| | | Immediately | No | No | No | No | No |
| | | after | peeling-off | peeling-off | peeling-off | peeling-off | peeling-off |
| | | formation | | | | | |
| | Water | Ultrasonic | Peeling-off | Peeling-off | Peeling-off | Peeling-off | Peeling-off |
| | immersion | wave for | to 5% | to approximately | to 5% | to 5% | to 50% |
| | test | 2 min | | 100% | | | |
| | | Ultrasonic | Peeling-off | Peeling-off | Peeling-off | Peeling-off | Peeling-off |
| | | wave for | to 20% | to approximately | to 30% | to 10% | to approximately |
| | | 30 min | | 100% | | | 100% |
| | | Ultrasonic | Peeling-off | Peeling-off | Peeling-off | Peeling-off | Peeling-off |
| | | wave for | to 40% | to approximately | to 40% | to 20% | to approximately |
| | | 60 min | | 100% | | | 100% |

| Sample No. | | | 6B | 7B | 8B | 9B | 10B |
|---|---|---|---|---|---|---|---|
| Base | First ink | | 3 | 3 | 3 | 2 | 2 |
| layer | wet thickness [μm] | | 10 | 2 | 10 | 2 | 10 |
| | Curing or | | OFF | OFF | OFF | 80° C. | 80° C. |
| | solidification | | | | | 10 min | 10 min |
| Print | Second ink | | 1 | 1 | 1 | 1 | 1 |
| layer | Platen heater [° C.] | | OFF | OFF | OFF | 60 | 60 |
| | Curing or | | 80° C. | 80° C. | 80° C. | 80° C. | 80° C. |
| | solidification | | 10 min | 10 min | 10 min | 10 min | 10 min |
| Base material | | | 1 | 2 | 2 | 1 | 1 |
| Evaluation | Image | Cloudiness | Observed | Observed | Observed | Observed | Observed |
| | quality | | | | | | |
| | X-cut test [Ratio] | | 10 | 10 | 10 | 10 | 10 |
| | Claw friction test | | ∘ | ∘ | ∘ | ∘ | ∘ |
| | | Immediately | No | No | No | No | No |
| | | after | peeling-off | peeling-off | peeling-off | peeling-off | peeling-off |
| | | formation | | | | | |
| | Water | Ultrasonic | Peeling-off | Peeling-off | Peeling-off | Peeling-off | Peeling-off |
| | immersion | wave for | to 20% | to 10% | to 40% | to 50% | to 80% |
| | test | 2 min | | | | | |
| | | Ultrasonic | Peeling-off | Peeling-off | Peeling-off | Peeling-off | Peeling-off |
| | | wave for | to 60% | to 90% | to 90% | to approximately | to approximately |
| | | 30 min | | | | 100% | 100% |
| | | Ultrasonic | Peeling-off | Peeling-off | Peeling-off | Peeling-off | Peeling-off |
| | | wave for | to 80% | to 90% | to 90% | to approximately | to approximately |
| | | 60 min | | | | 100% | 100% |

As illustrated in Table 2, in a case where the base layer was formed using the polyallylamine-containing ink, the print layer tended to become cloudy when the print layer was formed using the water-based ink. It is considered that this can be solved by studying the type of solvents of the first ink, the type of second ink, or the like, that is, by selecting a combination of the first ink and the second ink.

In addition, the print layer (base layer) which remains after 60 minutes from application of the ultrasonic waves could easily peel off by rubbing the print layer.

Further, it was found that the print layer (base layer) more easily peels off by being immersed in water in a case where the polyallylamine-containing ink was cured or solidified, and then the print layer was formed, than the case of forming the print layer by wet on wet.

### 3-1. Formation of Coating Layer

### (Sample No. 1C)

### <Coating Layer Forming Step>

First, a liquid coating film having a thickness of 22.9 μm was formed by supplying droplets of the third ink 1 by the bar coating method to cover a part of the print layer and a part of the base layer of Sample No. 5A.

Next, the liquid coating film was irradiated with an ultraviolet ray at room temperature (25° C.). In this manner, the liquid coating film was cured to form the coating layer. Note that the intensity of the ultraviolet ray was set to 466 mW/cm², and the energy quantity of the ultraviolet ray was set to 336 mJ/cm².

### (Sample No. 2C)

A coating layer was formed in the same manner as in Sample No. 1C except that the third ink 2 was used instead of the third ink 1.

### (Sample No. 3C)

A coating layer was formed in the same manner as in Sample No. 1C except that the coating layer was formed to completely cover the print layer and the base layer.

### 3-2. Evaluation

### <Quality Check of Coating Layer>

The coating layer was visually observed to evaluate whether the image quality is even.

### <Claw Rubbing Test>

This was carried out in the same manner as described above.

### <Water Immersion Test>

This was carried out in the same manner as described above.

The results thereof are illustrated in Table 3 below.

TABLE 3

| Sample No. | | | 1C | 2C | 3C |
|---|---|---|---|---|---|
| Base | First ink | | 1 | 1 | 1 |
| layer | wet thickness [μm] | | 0.1 | 0.1 | 0.1 |
| | Curing or solidification | | Ultraviolet | Ultraviolet | Ultraviolet |
| | | | irradiation | irradiation | irradiation |
| Print | Second ink | | 2 | 2 | 2 |
| layer | Platen heater [° C.] | | OFF | OFF | OFF |
| | Curing or solidification | | Ultraviolet | Ultraviolet | Ultraviolet |
| | | | irradiation | irradiation | irradiation |
| Coating | Third ink | | 1 | 2 | 1 |
| layer | wet thickness [μm] | | 22.9 | 22.9 | 22.9 |
| | Curing or solidification | | Ultraviolet | Ultraviolet | Ultraviolet |
| | | | irradiation | irradiation | irradiation |
| Base material | | | 3 | 3 | 3 |
| Evaluation | Image | Unevenness | OFF | Observed | — |
| | quality | | | | |
| | Claw friction test | | ∘ | — | — |
| | Water | Immediately | No | — | No |
| | immersion | after | peeling- | | peeling- |
| | test | formation | off | | off |
| | | After 91 h | * | — | — |
| | | Ultrasonic | * | — | No |
| | | wave for | | | peeling- |
| | | 30 min | | | off |

In Table 3, “*” indicates that peeling-off of the print layer was not observed in a portion covered with the coating layer, and peeling-ff of the print layer was observed in a portion which is not covered with the coating layer.

As illustrated in Table 3, it was clarified that, by forming the coating layer, the print layer was not peeled off even in the claw rubbing test.

In addition, it was confirmed that, by forming the coating layer, peeling-off of the print layer did not occur even after the immersion in water is performed for 91 hours and even by applying ultrasonic waves for 30 minutes.

### 4. Effect of Lapse of Time Under Normal-Temperature and Normal-Humidity Environment

### (Sample No. 1D)

A base layer and a print layer were formed in the same manner as in Sample No. 5A except that a substrate 3 having a size of 100 mm×160 mm was used.

### (Sample No. 2D)

A base layer, a print layer, and a coating layer were formed in the same manner as in Sample No. 3C except that the substrate 3 having a size of 100 mm×160 mm was used.

Next, regarding the print layer and the coating layer of Sample Nos. 1D and 2D, changes immediately after formation thereof and after being left for three months in a normal-temperature and normal-humidity environment were checked.

The results are illustrated in Table 4 below.

TABLE 4

| | | | Sample No. | | | |
|---|---|---|---|---|---|---|
| | | | 1D (without coating layer) | | 2D (with coating layer) | |
| | | | Elapsed time | | | |
| | | | Immediately | | Immediately | |
| | | | after | After 3 | after | After 3 |
| | | | formation | months | formation | months |
| Evaluation | Image | Smearing | Observed | Worse | Observed | No change |
| | quality | Gloss | — | — | Unevenness | Degraded |
| | | (irregularities) | | | | |
| | Claw friction test | | Δ | Δ | ∘ | Δ |
| | Water | Immediately | Peeling-off | Peeling-off to | No | No |
| | immersion | after | only at color | color density | peeling- | peeling- |
| | test | formation | density of 20% | of 40% | off | off |
| | | 30 min. | Peeling-off to | Peeling-off to | No | No |
| | | passed | color density | color density | peeling- | peeling- |
| | | | of 160% | of 240% | off | off |
| | | 1 h passed | Completely | Completely | No | No |
| | | | peeled off | peeled off | peeling- | peeling- |
| | | | Partial re- | | off | off |
| | | | adhesion | | | |

As illustrated in Table 4, in a case where the coating layer was not formed, and the sample is left for three months, a degree of smearing tended to be worse in the print layer (particularly, a portion having a light color). By forming the coating layer, the degree of smearing was not changed, but the gloss tended to decrease.

In addition, after being left for three months, the print layer easily peeled off in the claw rubbing test even in a case where the coating layer was formed. Note that, in the water immersion test, no change was observed.

Note that, in the print layer (image) of the sample, cyan, magenta, yellow, and black are printed at a print density of 20 to 100% (in 20% increments) for each color. In addition, regarding a mixed color of magenta and yellow, a mixed color of cyan and yellow, and a mixed color of cyan and magenta, printing is performed at a printing density of 40 to 200% (in 40% increments) for each color. Further, regarding a mixed color of cyan, magenta, and yellow, printing is performed at a print density of 60 to 300% (in 60% increments).

“Peeling off only at a color density of 20%” in Table 4 means that cyan at a print density of 20%, magenta at a print density of 20%, yellow at a print density of 20%, and black at a print density of 20% peel off.

### 5. Effect of Lapse of Time Under High-Temperature and High-Humidity Environment

Regarding the print layer and the coating layer of Sample Nos. 1D and 2D, changes immediately after formation and after being left for one day and three months in a high-temperature and high-humidity environment (35° C., 90% RH) were checked.

The results are illustrated in Table 5 below.

TABLE 5

| | | Sample No. | | | | | |
|---|---|---|---|---|---|---|---|
| | | 1D (without coating layer) | | | 2D (with coating layer) | | |
| | | Immediately | | | Immediately | | |
| | | after | After 1 | After 3 | after | After 1 | After 3 |
| Elapsed time | | formation | day | months | formation | day | months |
| Evaluation | Image quality | — | Occurrence | Gap | — | Occurrence of | Deterioration of |
| | | | of wrinkle | between | | irregularities | surface |
| | | | | pixels | | in surface | irregularities |
| | Claw friction | x | — | x Worse | ∘ | — | x |
| | test | | | than state | | | |
| | | | | immediately | | | |
| | | | | after | | | |
| | | | | formation | | | |

As illustrated in Table 5, in a high-temperature and high-humidity environment (under a severe environment), the image quality and the peeling-off strength tended to deteriorate over time even when the coating layer was formed.

In such a case, it is considered effective to remove the base layer, the print layer, and the coating layer from the base material to reuse the base material.

### 6. Study of Rubbing Resistance

### (Sample No. 1E)

A base layer and a print layer were formed in the same manner as in Sample No. 5A except that a substrate 3 having a size of 100 mm×160 mm was used.

### (Sample No. 2E)

A base layer, a print layer, and a coating layer were formed in the same manner as in Sample No. 3C except that the substrate 3 having a size of 100 mm×160 mm was used.

Next, a dry rubbing test and a wet rubbing test were conducted on the print layer and the coating layer of Sample Nos. 1E and 2E as follows.
Dry rubbing test: A Gakushin-type rubbing tester was used to cause dried cotton broadcloth having a height of 0 mm and a load of 1,000 g to reciprocate on the sample.
Wet rubbing test: A Gakushin-type rubbing tester was used to cause water-soaked cotton broadcloth having a height of 0 mm and a load of 1,000 g to reciprocate on the sample.

As a result, in the dry rubbing test, when the coating layer was not formed, the peeling-off of the print layer was observed when an reciprocating operation was performed 100 times. On the contrary, by forming the coating layer, no scratch was produced in the print layer even after the reciprocating operation was performed 2,000 times.

In addition, in the wet rubbing test, when the coating layer was not formed, a slight scratch was observed in the front surface of the print layer when the reciprocating operation was performed 2,000 times. On the contrary, by forming the coating layer, no scratch was produced in the print layer even after the reciprocating operation was performed 2,000 times.

From the above description, a high-quality print layer can be formed by appropriately combining the constituent material of the base layer and the constituent material of the print layer.

In a case where the quality of the print layer does not satisfy the required criteria, the print layer can be removed together with the base layer, so the base material can be reused.

In addition, if the print layer having the quality that satisfies the required criteria is formed, printed matter as a final product can be obtained by forming the coating layer. In such printed matter, the quality of the print layer can be maintained for a long period of time.

Further, in a case where the coating layer deteriorates over time in the final product, the base material can be reused by removing the base layer, the print layer, and the coating layer.

### REFERENCE SIGNS LIST

1 Base material
2 Base layer
2a Central base layer
2b Outer peripheral base layer
3 Print layer
3a Central print layer
3b Outer peripheral print layer
4 Coating layer
4a Central coating layer
4b Outer peripheral coating layer
S1 Base layer forming step
S2 Print layer forming step
S3 Print quality checking step
S4 Coating layer formation determining step
S5 Coating layer forming step
S6 Base layer removing step
S7 Temporary coating layer formation determining step
S8 Temporary coating layer forming step

1. A method for manufacturing printed matter, comprising:
a base layer forming step; a print layer forming step; a print quality checking step; and a post-processing step, wherein
in the base layer forming step, a base layer which is removable from a base material is formed on a front surface of the base material,
in the print layer forming step, a print layer is formed on a surface of the base layer on a side opposite to the base material,
in the print quality checking step, a quality of the print layer is checked, and
in the post-processing step, a coating layer that coats the print layer is formed or the print layer is removed together with the base layer from the base material depending on the quality of the print layer.

2. The method for manufacturing printed matter as set forth in claim 1, wherein the base layer includes a first base layer formed on the base material side and a second base layer which is formed on the first base layer on a side opposite to the base material and has a higher adhesion to the print layer than an adhesion of the first base layer to the print layer.

3. The method for manufacturing printed matter as set forth in claim 2, wherein the first base layer has a higher adhesion to the base material than an adhesion of the second base layer to the base material.

4. The method for manufacturing printed matter as set forth in claim 1, wherein the base layer is formed by a droplet ejection method or a bar coating method.

5. The method for manufacturing printed matter as set forth in claim 1, wherein the base layer has a size to the extent that the print layer is encompassed when the base material is viewed in a normal direction of the front surface.

6. The method for manufacturing printed matter as set forth in claim 1, wherein the print layer is formed by a droplet ejection method.

7. The method for manufacturing printed matter as set forth in claim 1, wherein the coating layer is formed by a droplet ejection method.

8. The method for manufacturing printed matter as set forth in claim 1, wherein the coating layer has a size to the extent that the base layer is encompassed when the base material is viewed in a normal direction of the front surface.

9. The method for manufacturing printed matter as set forth in claim 1, wherein the coating layer has a higher adhesion to the base material than an adhesion of the base layer to the base material.

10. The method for manufacturing printed matter as set forth in claim 1, wherein the quality of the print layer is at least one selected from cracking, smearing, cloudiness, and stickiness.

11. The method for manufacturing printed matter as set forth in claim 1, wherein the base layer is removed by at least one selected from contact with a solvent, ultraviolet irradiation, heating, and plasma treatment.

12. The method for manufacturing printed matter as set forth in claim 11, wherein the contact of the base layer with the solvent is performed by a method of immersing the base layer in the solvent.

13. The method for manufacturing printed matter as set forth in claim 12, wherein, when the base layer is immersed in the solvent, at least one selected from ultrasonic irradiation, heating, and swinging is performed.

14. The method for manufacturing printed matter as set forth in claim 1, further comprising a temporary coating layer forming step between the print layer forming step and the print quality checking step, wherein
in the temporary coating layer forming step, a temporary coating layer that covers the print layer is formed.

15. The method for manufacturing printed matter as set forth in claim 1, wherein the base material from which the print layer has been removed together with the base layer is subjected to the base layer forming step, the print layer forming step, the print quality checking step, and the post-processing step again.

16. The method for manufacturing printed matter as set forth in claim 1, wherein, in a case where the coating layer covering the print layer is formed, and then the print layer needs to be removed, a penetration portion penetrating the coating layer in a thickness direction is formed.
